(19) United States
(12) Patent Application Publication
(10) Pub. No.: US 2021/0197947 A1
(43) Pub. Date: Jul. 1, 2021

(54) Aerostat Display

(71) Applicant: Qingyuan Li, Shenzhen (CN)

(72) Inventor: Qingyuan Li, Shenzhen (CN)

(21) Appl. No.: 16/729,549

(22) Filed: Dec. 30, 2019

(51) Int. Cl. B64B 1/50; B64F 1/14; B64B 1/66; B64D 47/02; G09F 9/33

(52) U.S. Cl. CPC B64B 1/50; B64F 1/14; G09F 9/33; B64D 47/02; B64B 1/66

(57) ABSTRACT

The present disclosure provides aerostat display, which utilizes the aerial display by exploiting the visual residue of pointolites rotating around the outer surface of the aerostat on human eyes.

### FIELD OF INVENTION

The present invention relates to aerostat display, in particular to a device for realizing aerial display by exploiting the visual residue of pointolites that rotates near the outer surface of a aerostat to human eyes

### BACKGROUND OF INVENTION

There are some spherical LED displays on market, which are fixed indoors or outdoors by brackets or cables to display images such as the earth. Wherein the LED light source is fixed or rotated. The latter utilizes the visual residue of the rotating LED pointolites on the human eye. When the LED pointolites moved to a specific position, it would be turned on/off, so as to achieve the effect equivalent to regular display pixels lighting on/off.

NTT DoCoMo, a Japanese telecom operator invented the world's first spherical lighting UAV, which achieves high maneuverability via a drone at the spherical center, and utilizes the rotating LED pointolites to achieve the effect of aerial display on the visual residue of human eyes, and plans to exploit it in sports events or high-tech concerts, as well as in emergency situations to remind people. It is designed for high mobility and can be operated almost anywhere, however, the battery life is a big obstacle under current technology. Although high energy density can be achieved by fuel, the problem is that drones are generally not allowed to fly in crowded places.

In addition, the principle of the UAV spherical display is to utilize a drone at the spherical center to move a conventional, fixed hoisting spherical LED display. The embodiment needs to solve technical problems such as the interference of airflow generated by the rotating LED strips to fly the drone, as far as possible to reduce the structure weight, and it is very noisy. At present, it is only 0.88 meters in diameter. If it is enlarged enough to impress thousands or even tens of thousands of people at the stadium, the noise level will probably be close to that of a chopper, which greatly reduces its practicality, let alone the risk of accidents.

If a crash over a dense crowd while fuel used could flame a fire, causing panic and mass stamping on the crowd, the casualties would get close to a terrorist attack. Not to mention that drones may be hijacked and exploited by terrorists.

US Patent application 20090133299A1 includes a display balloon with a built-in rotating lighting array, but how to fit the lighting array into the balloon is a big problem, and the array size is greatly limited by the balloon opening.

U.S. Pat. No. 10,109,224 utilizes a rotating lighting array combining or grouping drones, motorized balloons and blimps, but the energy consumption is too expensive, especially for advertising, and it also increases accident rate.

### SUMMARY OF INVENTION

Aerostat includes captive balloons, free balloons, and airships, while the GAO (Government Accountability Office) defines aerostat as tethered balloons. The definition will be used below.

It can be envisaged that buoyancy is provided by the aerostat to counteract all the gravity of entire device, and meanwhile the visual residue of the pointolites on the outer surface of the aerostat to the human eye can be used to achieve low-altitude display. The aerostat can be moored to the ground or suspended on beams and other fixed points by ropes, and provide power through cables parallel to the ropes, and data to provide the content to be displayed or underlying implementation instructions to rotate and light the pointolites.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

It will be understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The spherical display UAV invented by NTT Docomo, due to the current energy density limitation of the power battery, it is difficult to achieve its intended high maneuverability goal. On the other hand, many real-world applications do not require mobility. Of course, if there is no need to pay a price, high mobility is of great significance, but the limitations of the existing technology hinder its commercial pace, not only the battery life, noise level and flight control, but also the prevention of wireless attacks and hijacking are all major difficulties.

Since the invention of airplanes, lighter-than-air aircraft, such as balloons and airships, have tended to decline. Because it is lighter than air, the air time is not limited by fuel, so it is superior in terms of economy and environmental conservation. Because its buoyancy does not depend on power, a low-power engine can be used for the propulsion system, which not only has low cost but also low noise. It is also very suitable for combining with solar power generation to become a quite environmentally friendly air transportation vehicle.

However, due to the principle that the surface area is enlarged less than the volume, the advantage of being lighter than air must be made huge to be effective. However, the large volume causes air resistance to be much greater than that of aircraft, and its speed is lower than the slowest helicopter, usually below 100 km/h, even the alleged fastest Zeppelin or modern airship does not exceed 150 km/h. This is even slower than modern land vehicles such as cars or trains, which are only a little faster than ships.

Especially, it is highly sensitive to wind. In addition to maneuvering and docking in strong winds, the difference between headwind and downwind flight times is so notable, and the ground speed can be even exhausted due to no sideslip flight in crosswind. Therefore, the airplanes replaced it and became the preferred means of transportation.

However, for those applications that do not urgently need high maneuverability for demonstration purposes, aerostat is more suitable than aircraft. After all, rapid changes will affect the performance of the display, and we all have the experience of watching a short video repeatedly many times. Secondly, the display for dense crowds also requires a huge surface, which could just exploite the “disadvantage” that the aerostat needs to be enlarged according to the principle that surface area scales up less than the volume, so that it needs to be made enormous. Third, it can greatly offset the shortcoming of high sensitivity to wind by fixing the unpowered balloon to the ground or hanging from a crossbeam by a rope or cable (if possible). No doubt, unpowered balloons must be recovered to weather through typhoon. However, aircraft flights can not continue to operate under such conditions as well.

U.S. Pat. No. 10,109,224 utilizes a rotating lighting array combining or grouping drones, power balloons and blimps, but it is limited to motorized. Under current technology, it is difficult for an electric multirotor to stay in the air for more than 25 minutes, and fuel is very dangerous to fly over dense crowd.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

I claim:

1. An aerostat display, comprising: pointolites, arc strip(s), envelope(s) and motor, wherein pointolites are embedded in said arc strip(s), said arc strip(s) are installed outside said envelope(s), said motor drives said arc strip(s) to rotate around the said envelope(s); said envelope(s) contains a gas lighter than air to generate buoyancy; said pointolites be turned on or off based on instructions when rotating to a specific position, so as to exploit the visual residue of human eye to form an image to be displayed.

2. The aerostat display according to claim 2, further comprising cable(s) to provide power and tether said aerostat display to the ground or other fixed points.

3. An aerostat display, comprising: pointolites, arc strip(s), envelope(s) and motor, wherein pointolites are embedded in said arc strip(s), said arc strip(s) are installed outside said envelope(s), said motor drives said arc strip(s) to rotate around the said envelope(s); said envelope(s) contains a gas lighter than air to generate buoyancy; said pointolites be turned on or off based on instructions when rotating to a specific position, so as to exploit the visual residue of human eye to form an image to be displayed.

4. The aerostat display according to claim 3, further comprising cable(s) to provide power and tether said aerostat display to the ground or other fixed points.

5. The aerostat display according to claim 3, wherein one of said cables transmits data or instructions required to display said image.

6. An aerostat display, comprising: pointolites, arc strip(s), envelope(s) and motor, wherein pointolites are embedded in said arc strip(s), said arc strip(s) are installed outside said envelope(s), said motor drives said arc strip(s) to rotate around the said envelope(s); said envelope(s) contains a gas lighter than air to generate buoyancy; said pointolites be turned on or off based on instructions when rotating to a specific position, so as to exploit the visual residue of human eye to form an image to be displayed.

7. The aerostat display according to claim 6, further comprising cable(s) to provide power and tether said aerostat display to the ground or other fixed points.

8. The aerostat display according to claim 6, wherein image to be displayed is generated via built-in or wirelessly transmitted data or instructions.
